(19) United States
(12) Patent Application Publication
(10) Pub. No.: US 2008/0292223 A1
(43) Pub. Date: Nov. 27, 2008

(54) High Strength Multi-Layer Bags

(76) Inventor: Roger Bannister, Crossett, AR (US)

Correspondence Address: R. Bennett Ford, 2355 Drusilla Lane, Baton Rouge, LA, 70809, US

(21) Appl. No.: 11/752,248

(22) Filed: May 22, 2007

(51) Int. Cl. B65D 30/08; B32B 1/08; B65D 30/14

(52) U.S. Cl. 383/114; 428/34.3; 493/287

(57) ABSTRACT

A plastic reinforced, gusseted pinch bag. The bag is preferably formed from a sheet of clay coated kraft paper. High quality graphics may be printed on the clay coating. A plastic matrix is laminated to the exterior of the sheet which is then formed into a gusseted tube and separated into sections. Each section is then closed at one end to form bags. The plastic matrix on the exterior of the bags will protect them from tears and punctures and help prevent spreading of any tears that may form. Additionally, the matrix and the adhesive used to laminate the matrix to the sheet will form a plastic coating on the exterior of the bags which will make the bags more resistant to moisture. The preferred adhesive and matrix will be transparent or very nearly so, allowing the graphics on the bags to be viewed without obstruction.

### BACKGROUND OF THE INVENTION

1. Field of the Invention

The invention relates to bags in general and to high strength combination paper and plastic bags in particular.

2. Prior Art

In the prior art many different types of products are bagged. Particularly with consumer goods, it has become important to be able to include high gloss multi-color graphic images on the bags. Consumers respond well to such marketing efforts in packaging. For example, it is well known that between similarly located items of like quality, the one with the more interesting and engaging packaging will typically sell more readily, often in spite of price advantages in the item in a duller package. As a result, manufacturers often insist that their packaging include high quality graphics.

With bagged goods, this demand for high quality graphics has been met in numerous ways. One is to provide a bag made from a clay coated kraft or similar paper. The clay coating allows high quality multi-color printing to be done on the bag.

Bagging products in paper bags invariably leads to tears in the bags. This can defeat the purpose of the high quality graphics, in that consumers often will not select a product if the packaging is torn. Additionally, the tears can lead to quality problems with the products in that the tear can allow moisture into the bag, which can cause certain products to deteriorate or become stale. Tears in the bags can also allow the contents of the bag to escape. At a minimum, such spills require store or warehouse personnel to spend time cleaning up the spill. At worst, the spills can create an unsafe condition in which persons may be injured in a fall. Accordingly, a bag meeting the following objectives is desired.

### OBJECTS OF THE INVENTION

It is an object of the invention to provide a bag having a surface suitable for printing high quality graphics.

It is an additional object of the invention to provide a bag with a reinforced coating for preventing tears.

It is another object of the invention to provide a bag with a reinforced coating for preventing punctures.

It is still another object of the invention to provide a bag with a reinforced coating for preventing ruptures in the bag from spreading.

It is yet another object of the invention to avoid or limit loss of product due to bag damage.

It is still another object of the invention to avoid or limit product spills due to bag damage.

### SUMMARY OF THE INVENTION

A plastic reinforced, gusseted pinch bag is disclosed. The bag is preferably formed from a sheet of clay coated kraft paper. High quality graphics may be printed on the clay coating. A plastic matrix is then laminated to the exterior of the sheet which is then formed into a gusseted tube and separated into sections. Each section is then closed at one end to form bags. The plastic matrix on the exterior of the bags will protect them from tears and punctures. The matrix will also help prevent spreading of any tears that may form, all of which will limit spillage or other losses of the contents of the bags. Additionally, the matrix and the adhesive used to laminate the matrix to the sheet will form a plastic coating on the exterior of the bag which will make the bag more resistant to moisture. The preferred adhesive and matrix will be transparent or very nearly so, allowing the graphics on the bag to be viewed without obstruction.

### BRIEF DESCRIPTION OF THE DRAWINGS

FIG. 1 is a perspective view showing a plastic matrix being laminated to a paper sheet to form a multi-layer sheet.

FIG. 2A is a perspective view showing one order in which a plastic matrix may be adhered to a paper sheet.

FIG. 2B is a perspective view showing another order in which a plastic matrix may be adhered to a paper sheet.

FIG. 2C is a perspective view showing another order in which a plastic matrix may be adhered to a paper sheet using two layers of adhesive.

FIG. 3A is a perspective view of an example of a scrim-type matrix.

FIG. 3B is a perspective view of an example of a weave-type matrix.

FIG. 3C is a perspective view of an example of a net type matrix.

FIG. 4 is a plan view of a preferred embodiment of a single detachable bag section.

FIG. 5 is a plan view of a multi-layered sheet segmented with perforations into a plurality of detachable bag sections.

FIG. 6 is a perspective view of a preferred embodiment of a detachable bag section being folded into a gusseted tube.

FIG. 7A is a side view of a preferred embodiment of a gusseted tube.

FIG. 7B is a plan view of a preferred embodiment of a gusseted tube.

FIG. 7C is an end view of a preferred embodiment of a gusseted tube.

FIG. 8A is a perspective view of a preferred embodiment of a gusseted tube being folded closed at one end to form a bag.

FIG. 8B is a perspective view of a preferred embodiment of a bag.

FIG. 9A is a perspective view of a preferred embodiment of a cutter.

FIG. 9B is a perspective view of a portion of a preferred embodiment of a life.

FIG. 10 is a perspective view of a preferred embodiment of a roller.

FIG. 11A is an end view of a preferred embodiment of a knife turning toward a roller prior to engaging a multi-layer sheet passing between the roller and the knife.

FIG. 11B is a perspective partial cut-away view of a preferred embodiment of a knife engaging a multi-layer sheet passing between the roller and the knife.

FIG. 11C is an end view of a preferred embodiment of a knife turning away from a roller after engaging with a multi-layer sheet passing between the roller and the knife.

FIG. 11D is an enlarged view of the circled portion of FIG. 11C showing the portion of the multi-layer sheet severed by the knife.

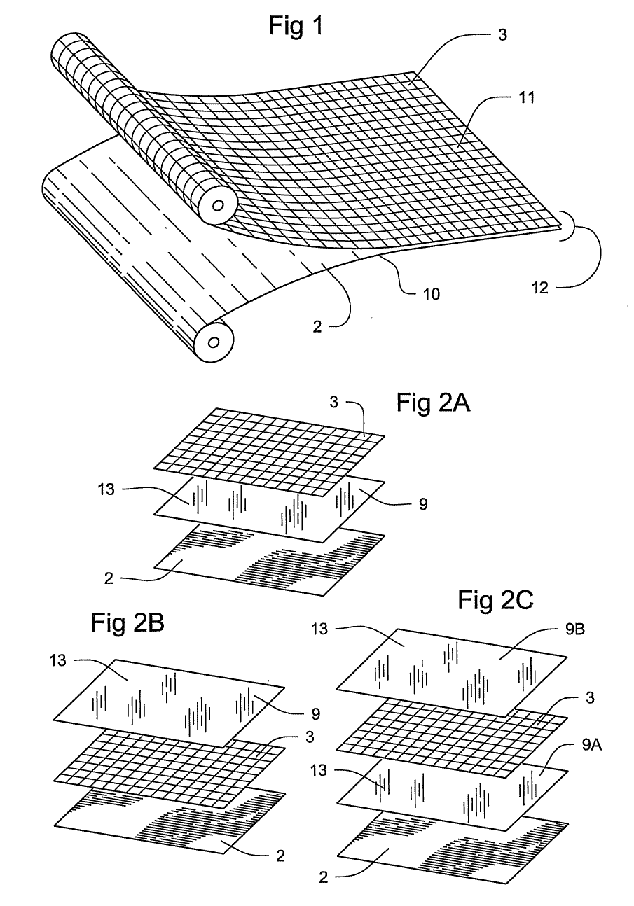

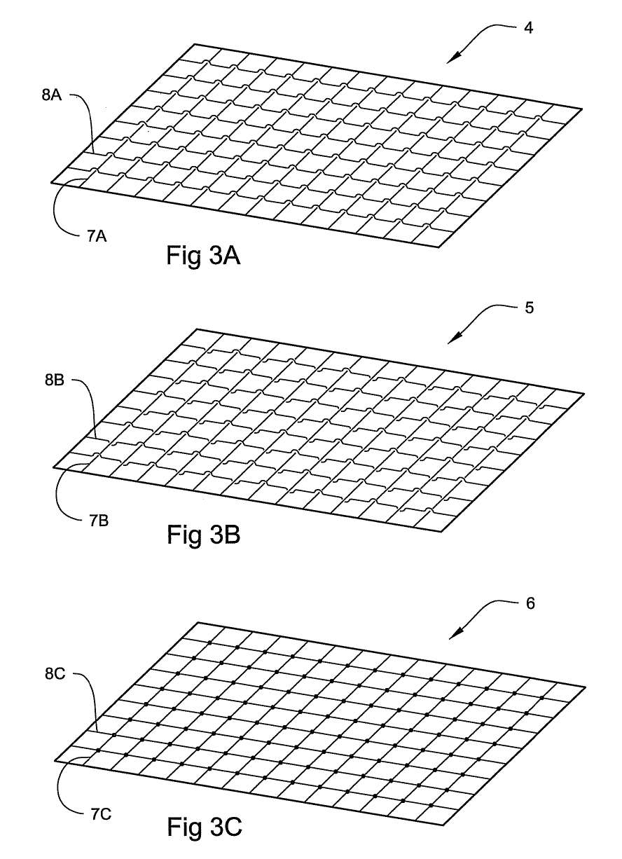

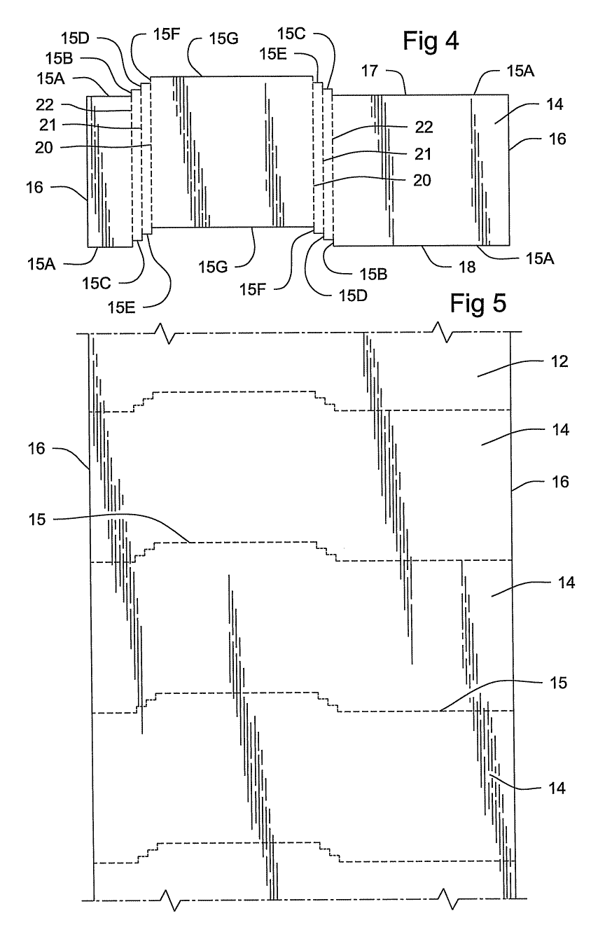

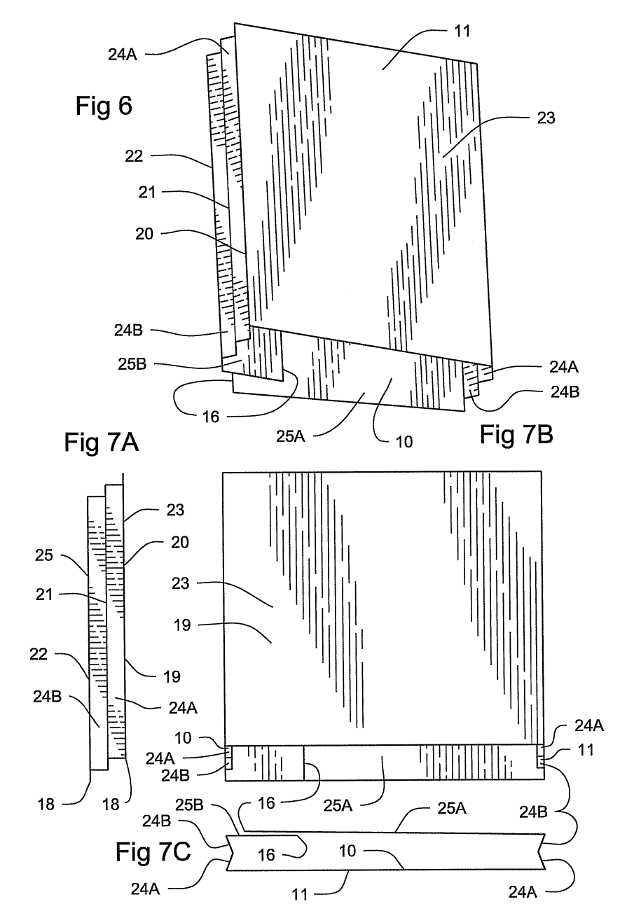

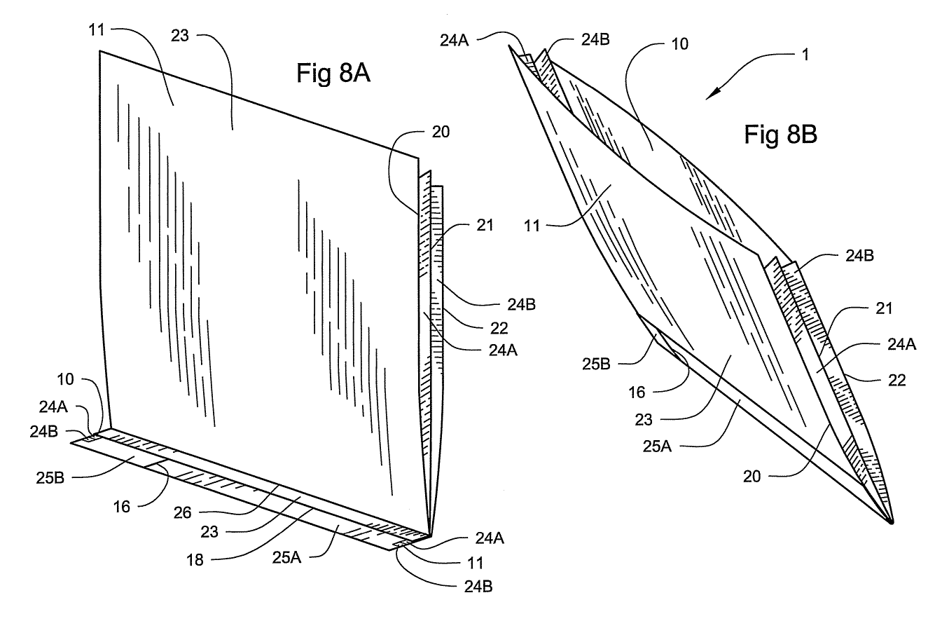

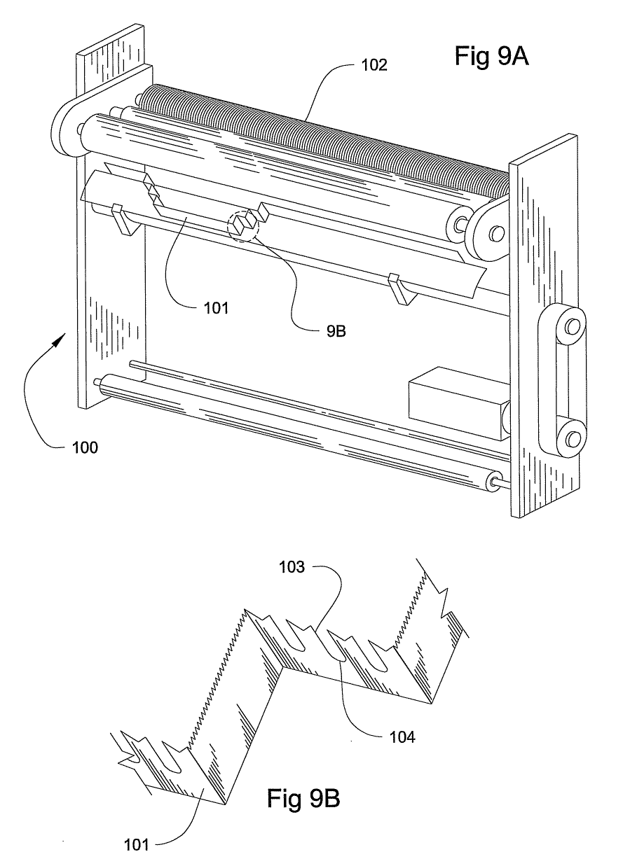

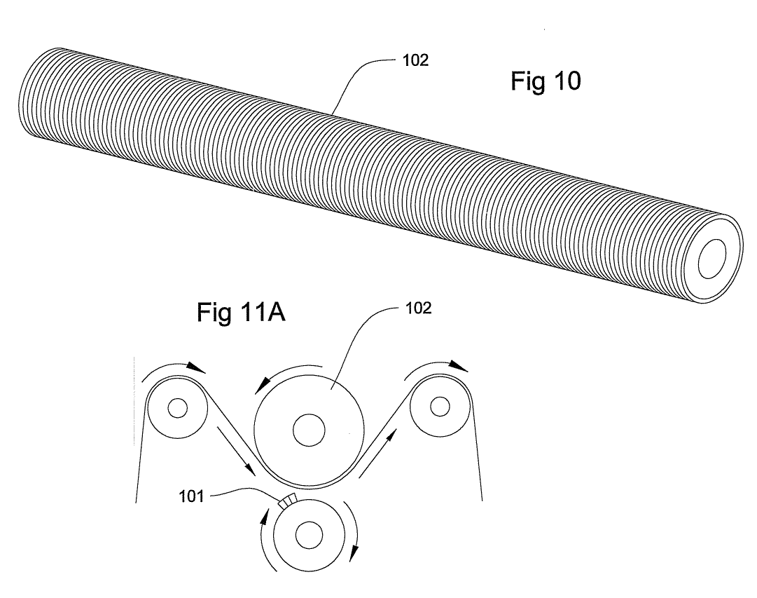

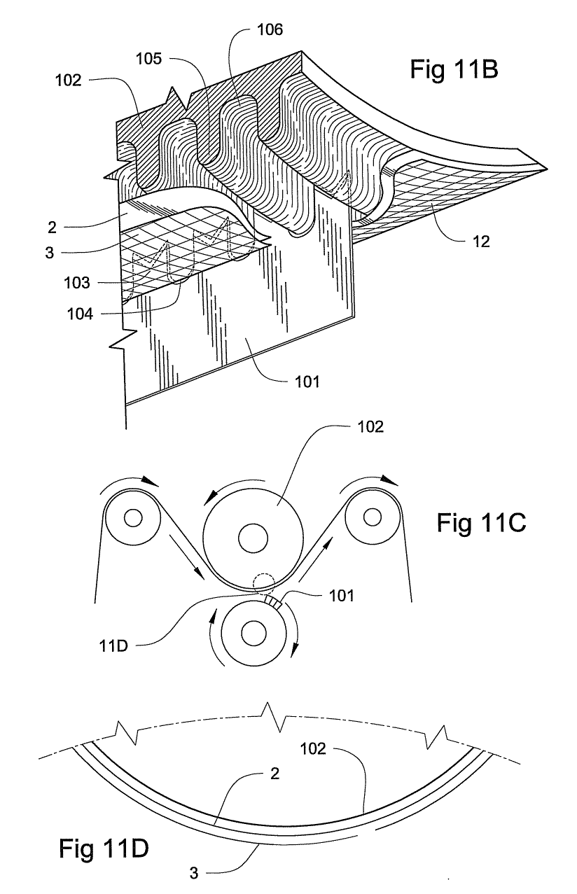

### DETAILED DESCRIPTION OF THE PREFERRED EMBODIMENT

The invention relates to a method of making a bag 1. In the preferred embodiment, bag 1 will be formed from a sheet 2. Sheet 2 will preferably be comprised of paper and most preferably of a clay coated kraft paper such as the Kemigraph brand paper available from KemiArt, Inc. of 192 Wilcox Drive in Bartlett, Ill.

The clay coated side of sheet 2 will make sheet 2 particularly suited for printing. High quality high gloss printing may be done on the clay coated side of sheet 2. Such printing is commonly performed on paper bags containing consumer products such as dog food, garden products and the like. These printing processes are well known in the paper bag field and will not be described in detail here.

Once whatever printing is to be performed on sheet 2 is complete, sheet 2 will be laminated with a plastic matrix 3. Matrix 3 may be a scrim 4, a weave 5, a net 6, or any other conventional webbing pattern or combinations thereof. In the preferred embodiment of scrim 4, matrix 3 is comprised of a first layer of plastic fibers 7A positioned generally parallel to each other and a second layer of plastic fibers 8A also positioned generally parallel to each other but on top of and at an angle to first layer of fibers 7A. In scrim 4, layers 7A, 8A are preferably perpendicular to each other, but each individual strand is not connected to any other strand.

In the preferred embodiment of weave 5, matrix 3 is comprised of a first layer of plastic fibers 7B positioned generally parallel to each other. A second layer of generally parallel plastic fibers 8B is also provided. Second layer of plastic fibers 8B is positioned at an angle to first layer 7B, and preferably at a right angle; however, which fiber is on top and which is on bottom will alternate at each intersection of fibers. That is, the fibers 7B and 8B are woven together. The individual fibers are not physically connected to each other at the intersections.

The preferred embodiment of net 6 also has a first layer of plastic fibers 7C and a second layer of plastic fibers 8C. The fibers of layers 7C and 8C are also arranged at an angle to each other; however, at each intersection, the fibers of layers 7C and 8C are physically joined together in net 6.

Matrix 3 may be formed of a variety of plastic fibers. Preferred plastic fibers include polyester, polyethylene, polypropylene, and nylon. In the preferred embodiment the plastic fibers comprising matrix 3 will have a diameter of between about 2.0 millimeters and about 8.5 millimeters. In the preferred embodiment, matrix 3 will be between about forty percent and about eighty percent open. In the most preferred embodiment, the plastic fibers are transparent or nearly so. In the most preferred embodiment, a polyethylene scrim is used for matrix 3. Suitable polyethylene scrim may be obtained from Atlanta Nisseld CLAF, Inc. (ANCI) of Kennesaw, Ga.

Whichever version of matrix 3 is used, matrix 3 is laminated to sheet 2. This may be done by placing a layer of adhesive 9 on sheet 2 and then positioning matrix 3 on sheet 2. Alternatively, matrix 3 may be positioned on sheet 2 followed by a layer of adhesive 9 positioned over sheet 2 and matrix 2. In the most preferred embodiment, a first layer of adhesive 9A is positioned on sheet 2 followed by matrix 3 followed by a second layer of adhesive 9B. It will be appreciated that adhesive 9 will secure matrix 3 to sheet 2. Once matrix 3 is laminated to sheet 1, sheet 2 will form an inner layer 10 and matrix 3 and adhesive layer(s) will form an outer layer 11 of a multi-layer sheet 12.

Sheet 2 and matrix 3 will most preferably be provided in rolls. Suitable machinery to spool sheet 2 and matrix 3 off of their respective rolls and into multi-layer sheet 12 is available from the Davis Standard, Corp. of Somerville, N.J. or the Starlinger Corp. of Weissenbach, Austria. The selection of a suitable adhesive 9 will depend on the materials that comprise the fibers of matrix 3. For example, where matrix 3 is comprised of polyethylene fibers, adhesive 9 will also preferably be comprised of a molten polyethylene. A thin layer 13 of molten polyethylene will be extruded directly onto sheet 2 immediately before and/or after matrix 3 is deposited on sheet 2. In the preferred embodiment each layer 13 of molten polyethylene will be deposited to a thickness of about 0.5 to about 4.0 millimeters. When contact with moisture in the environment or containing a product with a high grease content is a concern, polyethylene may be deposited at the upper end of this range or even at thicknesses beyond this range, as needed according to the application. Equipment suitable for depositing a molten layer 13 of adhesive 9 onto sheet 2 may be obtained from the Davis Standard, Corp. or the Starlinger, Corp.

Like matrix 3, adhesive 9 will preferably be transparent or nearly so. When matrix 3 and adhesive 9 are transparent, they will not obstruct viewing of the printing on the surface of sheet 2.

Once multi-layer sheet 12 is formed, it will be cut into detachable bag sections 14. This is preferably performed by forming a plurality of staggered perforated lines 15 extending across sheet 12. Perforated lines 15 will preferably be comprised of several staggered sections.

Beginning at outer edges 16 of multi-layer sheet 12, a first section 15A is cut on both sides of sheet 12. Sections 15A are preferably cut substantially perpendicular to sides 16.

At the ends of sections 15A distal from edges 16, a second section 15B is cut on both sides of sheet 12. Sections 15B are preferably cut substantially parallel to outer edge 16.

Beginning at the ends of sections 15B distal from their respective sections 15A, a third section 15C is cut on both sides of sheet 12. Sections 15C are preferably cut substantially perpendicular to sides 16.

At the ends of sections 15C distal from sections 15B, a fourth section 15D is preferably cut on both sides of sheet 12. Sections 15D are preferably cut substantially parallel to edges 16.

At the ends of sections 15D distal from sections 15C, a fifth section 15E is preferably cut on both sides of sheet 12. Sections 15E are preferably cut substantially perpendicular to edges 16.

At the ends of sections 15E distal from sections 15D, a sixth section 15F is preferably cut on both sides of sheet 12. Sections 15F are preferably cut substantially parallel to edges 16.

At the ends of sections 15F distal from their respective sections 15E, a seventh section 15G is cut. Section 15G is preferably cut substantially perpendicular to edges 16. Section 15G will preferably connect opposite sections 15F.

From the foregoing, it will be appreciated that perforated line 15 will extend across multi-layer sheet 12 and will contain seven horizontal perpendicular to edges 16) sections and six vertical (parallel to edges 16) sections. Horizontal sections 15G should be approximately the same length as or slightly shorter than the combined length of horizontal sections 15A. Horizontal sections 15C and 15E will be approximately the same length. Vertical sections 15B, 15D, and 15E can vary in length depending on how much stagger is desired in finished bag 1. However, each pair of vertical sections 15B will preferably be the same length. Likewise, with pairs of vertical sections 15D and 15F.

As noted above, a plurality of perforated lines 15 will be formed across multi-layer sheet 12. Each pair of perforated lines 15 will delineate detachable bag sections 14, with one line 15 forming the upper edge 17 of bag section 14 and the other line 15 forming the lower edge 18 of bag section 14. However, in the preferred embodiment cutting perforated lines 15 will not separate multi-layer sheet 12. Rather, multi-layer sheet 12 will only have been perforated. It will still be possible to handle multi-layer sheet 12 as a unit. However, perforated lines 15 will make it possible to separate bag sections 14 from sheet 12 by applying a lateral force to sections 14, when desired.

In the preferred embodiment, a cutter 100 will be used to form perforated lines 15 in each bag section 14. Cutter 100 will preferably comprise a servo driven rotable knife 101 and roller 102. Knife 101 will preferably comprise a plurality of teeth 103. Each tooth 103 will preferably be shaped like an elongated “M,” with all of the exterior edges being sharp. There will be a gap 104 between each tooth 103; however, the edge of knife 101 will preferably be sharp in gap 104.

Roller 102 will preferably be provided with a plurality of ridges 105 and valleys 106. Teeth 103 will correspond with valleys 106 and gaps 104 will correspond to ridges 105. Knife 101 will preferably rotate in the same direction that sheet 12 is moving. The servo will coordinate the rate of rotation of knife 101 with the rate of advance of sheet 12 so that perforated lines 15 are properly spaced and located on sheet 12. That is, sheet 12 will be printed with the desired design for bags 1. It will be important that perforated lines 15 be formed so that these designs are located between lines 15, rather than forming lines 15 in the middle of each design. Similarly, it will be important that lines 15 be located the same distance apart so that bags 1 will be of uniform size. The necessary coordination between knife 101 and sheet 12 is accomplished with the servo.

The shape of knife 101 will mirror the desired shape of lines 15. As described above, lines 15 will preferably have a generally stair step shape. Knife 101 will be similarly shaped. However, the configuration of teeth 103 will preferably change depending on which portion of lines 15 is to be cut by knife 101. In the portions of knife 101 that are to cut the sections of line 15 that are generally perpendicular to edges 16 of sheet 12, teeth 103 will be about 3/16 of an inch wide and each gap 104 between teeth will be about 1/16 of an inch wide. In these portions of line 15, knife 101 will preferably perforate sheet 12. These portions of knife 101 will also preferably be formed from hardened steel and have a thickness of about 0.0062 inches.

In the portions of knife 101 that are to cut the sections of line 15 that are generally parallel to edges 16 of sheet 12, knife 101 will be serrated with much finer teeth. There may be as many as three or four teeth per quarter inch of knife 101 in these sections. These finer toothed sections of knife 101 will be positioned to align with a single valley 106 in roller 102. Here, knife 101 is intended to completely sever sheet 12, rather than merely perforating it. These portions of knife 101 are preferably formed from spring steel and have a thickness of about 0.025 inches.

Suitable knives 101 may be obtained from the DSW Converting Knives, Inc. of Birmingham, Ala. Roller 102 is preferably machined to match knife 101.

The depth to which knife 101 cuts will be important in the preferred embodiment. As described below, multi-layer sheet 12 will be formed into bag sections 14. Each bag section 14 will then be separated from sheet 12, again as described below. Breaking the bag sections 14 from sheet 12 is easily enough accomplished using prior art methods if the bag section 14 is connected to sheet 12 solely by perforated paper. However, multi-layer sheet 12 will be comprised of a plastic matrix 3 laminated to a paper sheet 2. The strands that make up matrix 3 will be much stronger than perforated paper sheet 2. If any of them extend uncut across line 15, it may be difficult to effectively separate bag sections 14 from sheet 12.

The inventor contemplates addressing this difficulty by positioning knife 101 and roller 102 relative to each other so that knife 101 severs matrix 3 completely, but only perforates the paper portion 2 of sheet 12. (Except in those portions of line 15 that are generally parallel to edges 16, where paper 2 and matrix 3 will preferably be complete severed.) In the preferred embodiment, the tolerance between knife 101 and roller 102 is adjustable, as the tolerance required will depend upon the thickness of paper 2 and matrix 3. Typical tolerances will range from about one twenty thousandth ( 1/20,000) to about on thirty-second ( 1/32) of an inch, though larger or smaller tolerances could be required depending on the thickness of the components of sheet 12. In practice, the relative position of knife 101 to roller 102 will be adjusted until the desired cut is obtained, namely matrix 3 is completely severed but paper 2 is only perforated.

To accomplish the desired cut using the preferred embodiment of knife 101, knife 101 should preferably face the side of sheet 12 to which matrix 3 has been laminated. Where matrix 3 is to be positioned on the exterior of bag 1, knife 101 will typically be positioned below roller 102 so that as sheet 12 passes under roller 102 with the side of sheet 12 containing matrix 3 facing down, knife 101 can rotate up toward sheet 12 and roller 102 and engage sheet 12.

After perforated lines 15 are formed, a gusseted tube 19 will preferably be formed from multi-layer sheet 12. Multi-layer sheet 12 will be folded along fold lines 20 that extend from upper edge 17 to lower edge 18 along lines that include vertical sections 15F. Multi-layer sheet 12 will also be folded along fold lines 21 that extend from upper edge 17 to lower edge 18 along lines that include vertical sections 15D. Finally, multi-layer sheet will be folded along fold lines 22 that extend from upper edge 17 to lower edge 18 along lines that include vertical sections 15B. Equipment suitable for folding multi-layer sheet 12 is available from Windomeller & Hoelscher KG of Lengerich, Germany or the Strong-Robinette Machine Corporation of Bristol, Tenn.

The folds made along fold lines 20 will preferably be made in a direction that will fold inner layer 10 of multi-layer sheet 12 toward inner layer 10 of multi-layer sheet 12 in the region of sheet 12 proximate fold line 20. The folds made along fold lines 21 will preferably be made in a direction that will fold outer layer 11 of multi-layer sheet 12 toward outer layer 11 of multi-layer sheet 12 in the region of sheet 12 proximate to fold line 21. The folds made along fold lines 22 will preferably be made in a direction that will fold inner layer 10 of multi-layer sheet 12 toward inner layer 10 of multi-layer sheet 12 in the region of sheet 12 proximate to fold lines 22.

Folding sheet 12 in the foregoing fashion will create a front face section 23 between sections 15G of upper and lower edges 17, 18 and between fold lines 20. It will also create first sidewall sections 24A between sections 15E of upper and lower edges 17, 18 and between fold lines 20 and 21. Second sidewall sections 24B will be formed between sections 15C of upper and lower edges 17, 18 and between fold lines 21 and 22. Folding sheet 12 in this manner will also create first and second rear face sections 25A and 25 B between sections 15A of upper and lower edges 17, 18 and between fold lines 22 and edges 16. In all of the foregoing sections, the vertical dimension will be that dimension that is perpendicular to both upper and lower edges 17, 18.

When sheet 12 is folded in the foregoing fashion, rear face sections 25A and 25B will be substantially parallel front face section 23 and will be positioned so that edges 16 meet. Gusseted tube 19 is formed when edges 16 are joined. Edges 16 may be joined together so that inner layer 10 of rear face section 25A is in contact with inner layer 10 of rear face section 25B. In the preferred embodiment when inner layer 10 is comprised of kraft paper, this will allow for a paper to paper connection for which a paper to paper adhesive may be used. Similarly, edges 16 may be joined together so that outer layer 11 of rear face 25A is in contact with outer layer 11 of rear face 25B. In the preferred embodiment, when outer layer 11 is comprised of polyethylene, this will allow for a plastic to plastic connection for which a plastic adhesive may be used. Edges 16 may also be joined by allowing them to overlap so that inner layer 10 of rear face section 25A is in contact with outer layer 11 of rear face section 25B. In the preferred embodiment, when outer layer 11 is comprised of polyethylene and inner layer 10 is comprised of kraft paper, this will allow for a paper to plastic connection, for which an adhesive such as may be used. In all of the foregoing conditions, the inventor contemplates using a polyethylene adhesive, preferably the 0.008 hot melt available from H.B. Fuller Co. of St. Paul, Minn.

Once edges 16 are joined together rear face sections 25A and 25B will form a rear face section 25. Gusseted sidewalls 24 will also be formed by sidewall sections 24A and 24B. Sidewalls 24 will connect front face section 23 to rear face section 25.

It will be appreciated that staggering lines 15 in the manner described above will cause lower edge 18 of front face 23 to be vertically displaced from lower edge 18 of rear face 25. Similarly, staggering lines 15 will also cause each lower edge 18 of sidewall sections 24A and 24B to be vertically offset relative to each other and with respect to lower edges 18 of front and rear faces 23, 25. It will also cause lower edge 18 of sidewall sections 24A, 24B to be vertically positioned between lower edge 18 of front face 23 and lower edge 18 of rear face 25.

When gusseted tubes 19 are formed, it will often be desirable to separate each gusseted tube 19 from sheet 12. This can be done by applying a lateral force to the terminal gusseted tube 19 strong enough to break perforated line 15 that forms upper edge 17 of gusseted tube 19. Equipment suitable for detaching each gusseted tube 19 is available from Windomeller & Hoelscher KG or the Strong-Robinette Machine Corporation.

Bag 1 maybe formed from gusseted tube 19 by closing one end of gusseted tube 19. This is preferably accomplished by applying adhesive, such as H.B. Fuller's 0.008 hot melt, to front face 23. Tube 19 would then be folded along a line 26 generally parallel and proximate to lower edge 18 of front face 23. This will place a portion of the outer surface 11 of front face 23 into contact with itself. It will also place a portion of the inner surface 10 of rear face 25 into contact front face 23. Additionally, it will place a portion of the inner and outer surfaces 10, 11 of sidewalls 24 into contact with front face 23. The adhesive will secure all of the foregoing together, securely closing one end of tube 19 and forming bag 1. Bags that close in the foregoing manner are sometimes known as “pinch bags.” Equipment suitable for sealing one end of tube 19 is available from Windomeller & Hoelscher KG or the Strong-Robinette Machine Corporation.

Once bag 1 has been formed, it may be filled with whatever bag 1 is intended to hold and the other end sealed in substantially the same fashion as described above with respect to the first end.

The finished bag 1 will be a bag capable of bearing high quality graphics suitable for effectively marketing the contents of bag 1 that also has a strong puncture and tear resistant coating on its exterior. This coating will protect bag 1 from damage during shipping and while stored in a retail environment. Additionally, the coating will help prevent any tears or punctures that bag 1 may develop from spreading. This can minimize spillage from bag 1, reducing the potential for slip and fall injuries.

These and other modifications for the manufacture of bag 1 will be apparent to those of skill in the art from the foregoing disclosure and drawings and are intended to be encompassed by the scope and spirit of the following claims.

I claim:

1. A tube for forming a pinch bag comprising a front face and a rear face and gusseted sidewalls extending therebetween, said rear face having a bottom edge and a top edge and a vertical dimension extending therebetween, said sidewalls each having a bottom edge and a top edge and a vertical dimension extending therebetween, and said front face having a bottom edge and a top edge and a vertical dimension extending therebetween, wherein said bottom edge of said rear face and said bottom edge of said front face are vertically displaced with respect to each other and wherein said bottom edges of each of said sidewalls are positioned between said bottom edge of said rear face and said bottom edge of said front face;
wherein said front face, said rear face, and said sidewalls are comprised of an inner layer and an outer layer laminated to said inner layer and wherein said inner layer is comprised of paper and wherein said outer layer is comprised of a plastic matrix.

2. A tube for forming a pinch bag according to claim 1 wherein said matrix is provided in the form of a net.

3. A tube for forming a pinch bag according to claim 1 wherein said matrix is provided in the form of a scrim.

4. A tube for forming a pinch bag according to claim 1 wherein said matrix is provided in the form of a weave.

5. A tube for forming a pinch bag according to claim 1 wherein said plastic comprises polyester.

6. A tube for forming a pinch bag according to claim 1 wherein said plastic comprises polypropylene.

7. A tube for forming a pinch bag according to claim 1 wherein said plastic comprises nylon.

8. A tube for forming a pinch bag according to claim 1 wherein said plastic comprises polyethylene.

9. A tube for forming a pinch bag according to claim 8 wherein said outer layer comprises a first sub-layer of adhesive and a second sub-layer of polyethylene matrix.

10. A tube for forming a pinch bag according to claim 9 wherein said first sub-layer of adhesive comprises polyethylene.

11. A tube for forming a pinch bag according to claim 9 wherein said outer layer further comprises a third sub-layer of adhesive.

12. A tube for forming a pinch bag according to claim 11 wherein said third sub-layer of adhesive comprises polyethylene.

13. A tube for forming a pinch bag according to claims 1, 2, 3, 4, 5, 6, 7, 8, 9, 10, 11, or 12 wherein said inner layer is comprised of clay coated craft paper.

14. A pinch bag made from a tube according to claim 1 wherein one end of said tube is closed by
(a) folding said tube along a line generally parallel and proximate to said bottom edge of said front face, whereby a portion of said front face will be folded over into contact with said front face and a portion of said sidewalls will be folded over into contact with said front face and a portion of said rear face will be folded over into contact with said front face; and
(b) positioning adhesive between said front face and at least one of said folded portions.

15. A pinch bag made from tubing according to claim 14 wherein said adhesive is positioned between said front face and all of said folded portions.

16. A pinch bag made from tubing according to claim 14 wherein said inner layer of said rear face is folded into contact with said outer face of said front face.

17. A method of forming a tube for forming a pinch bag comprising
a. laminating a plastic matrix to a sheet of paper to form a multi-layered sheet having edges;
b. completely severing said plastic matrix along a pre-selected line on said multi-layered sheet;
c. perforating said portion of said multi-layered sheet comprising said sheet of paper along said same pre-selected line on said multi-layered sheet;
d. folding said multi-layered sheet so that said edges overlap;
e. adhering said edges together; and
f. applying a force to a terminal section of said multi-layered sheet to break said perforation and thereby separate said terminal section from said multi-layered sheet.

18. A method of forming a tube for forming a pinch bag according to claim 17 wherein said step of completely severing said plastic matrix and said step of perforating said portion of said multi-layered sheet comprising said sheet of paper are performed simultaneously.
